(19) United States
(12) Patent Application Publication
(10) Pub. No.: US 2025/0199798 A1
(43) Pub. Date: Jun. 19, 2025

(54) CONTROL DEVICE, NON-TRANSITORY COMPUTER-READABLE RECORDING MEDIUM STORING COMPUTER-READABLE INSTRUCTIONS FOR CONTROL DEVICE, AND METHOD EXECUTED BY CONTROL DEVICE

(71) Applicant: BROTHER KOGYO KABUSHIKI KAISHA, Nagoya (JP)

(72) Inventor: Kentaro ARAI, Nagoya (JP)

(21) Appl. No.: 18/982,352

(22) Filed: Dec. 16, 2024

(30) Foreign Application Priority Data
Dec. 18, 2023 (JP) 2023-212786

(51) Int. Cl. G06F 8/65

(52) U.S. Cl. CPC G06F 8/65

(57) ABSTRACT

A control device may include a processor; and a memory storing computer-readable instructions. The computer-readable instructions, when executed by the processor, may cause the control device to: detect a change of a specific setting value from a first value to a second value in a communication device; in a case where the change of the specific setting value from the first value to the second value is detected, determine whether an update process is to be executed based on changed contents of the specific setting value, wherein the update process is for updating data stored in the communication device to address vulnerability of the communication device due to the change of the specific setting value of the communication device; and in a case where it is determined that the update process is to be executed, execute the update process.

### REFERENCE TO RELATED APPLICATION

This application claims priority to Japanese Patent Application No. 2023-212786 filed on Dec. 18, 2023. The entire content of the priority application is incorporated herein by reference.

### BACKGROUND ART

A network system including a plurality of information processing devices is known. In this technology, when a first information processing device encounters a DOS attack, the other information processing devices change their port numbers corresponding to specific programs used to communicate with the first information processing device in order to prevent the DoS attack.

### SUMMARY

The disclosure herein provides a novel technology for addressing vulnerabilities of a communication device.

The disclosure herein provides a control device comprising a processor and a memory storing computer-readable instructions. The computer-readable instructions, when executed by the processor, may cause the control device to: detect a change of a specific setting value from a first value to a second value in a communication device, wherein the specific setting value corresponds to a specific setting item related to communication; in a case where the change of the specific setting value from the first value to the second value is detected, determine whether an update process is to be executed based on changed contents of the specific setting value, wherein the update process is for updating data stored in the communication device to address a vulnerability of the communication device resulting from the change of the specific setting value in the communication device; and in a case where it is determined that the update process is to be executed, execute the update process.

According to the configuration above, the control device detects a change of the specific setting value from the first value to the second value in the communication device, and then, if determining that the update process is to be executed, executes the update process. The update process is for updating data stored in the memory of the communication device to address a vulnerability of the communication device resulting from the change of the specific setting value in the communication device. Thus, the communication device can address the vulnerability resulting from the change of the specific setting value.

The computer-readable instructions for the control device, a non-transitory computer-readable recording medium storing the computer-readable instructions, and a method executed by the control device are also novel and useful.

### BRIEF DESCRIPTION OF DRAWINGS

FIG. 1 shows a configuration of a communication system.

FIG. 2 shows contents of tables.

FIG. 3 shows a sequence diagram according to a first embodiment.

FIG. 4 shows a sequence diagram according to the first embodiment continued from FIG. 3.

FIG. 5 shows a sequence diagram according to a second embodiment.

FIG. 6 shows a sequence diagram according to the second embodiment continued from FIG. 5.

### DESCRIPTION

### First Embodiment

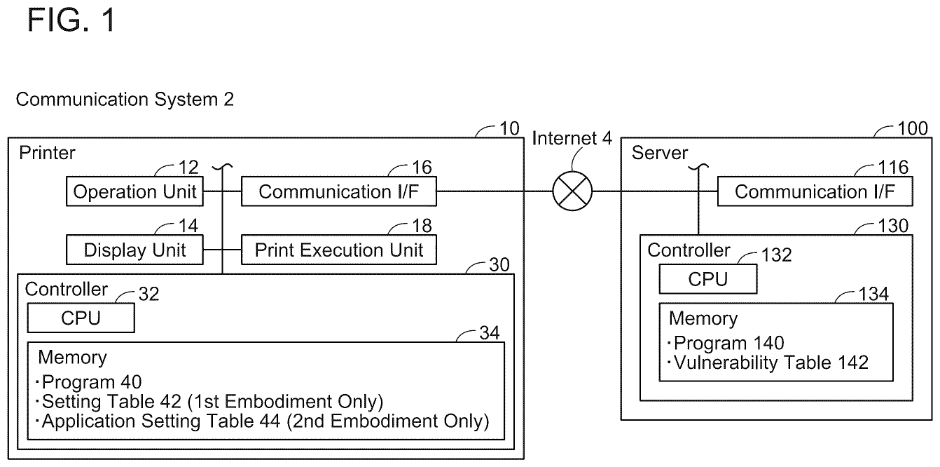

### Configuration of Communication System 2: FIG. 1

As shown in FIG. 1, a communication system 2 comprises a printer 10 and a server 100. The printer 10 and the server 100 are communicable with each other via the internet 4.

### Configuration of Printer 10

The printer 10 is a peripheral device (e.g., a peripheral device of a terminal (not shown)) configured to execute a print function. The printer 10 comprises an operation unit 12, a display unit 14, a communication interface 16, a print execution unit 18, and a controller 30. Hereinafter, an interface is abbreviated as “I/F”.

The operation unit 12 comprises a plurality of keys. A user can input various instructions to the printer 10 by operating the operation unit 12. The display unit 14 is a display configured to display various information. The display unit 14 also functions as a so-called touch screen (i.e., an operation unit). The communication I/F 16 is connected to the internet 4. The communication I/F 16 may be a wireless I/F or a wired I/F. The print execution unit 18 comprises a print mechanism of inkjet scheme, laser scheme, or the like.

The controller 30 comprises a CPU 32 and a memory 34. The memory 34 comprises a main storage and an auxiliary storage, which are not shown. The CPU 32 is configured to execute various processes according to a program 40 stored in the auxiliary storage of the memory 34. Specifically, the CPU 32 loads the program 40 from the auxiliary storage to the main storage and executes the program 40 to execute the various processes. The main storage is for example a RAM and a cache memory. The auxiliary storage may be for example a flash memory, an SSD (solid state drive), a ROM, or a combination thereof. The memory 34 further stores a setting table 42.

### Configuration of Server 100

The server 100 is established on the internet 4 by the vendor of the printer 10. In a modification, the server 100 may be established on the internet 4 by a business operator different from the vendor. In another modification, the vendor of the printer 10 need not prepare hardware for the server 100 and may use an environment provided by an external cloud computing service. In this case, the vendor of the printer 10 may prepare a program (i.e., software) for the server 100 and introduce it to the above-mentioned environment to implement the server 100.

The server 100 comprises a communication I/F 116 and a controller 130. The communication I/F 116 is connected to the internet 4. The controller 130 comprises a CPU 132 and a memory 134. The CPU 132 is configured to execute various processes according to a program 140 stored in the memory 134. The memory 134 is configured of a volatile memory, a non-volatile memory, etc. The memory 134 further stores a vulnerability table 142.

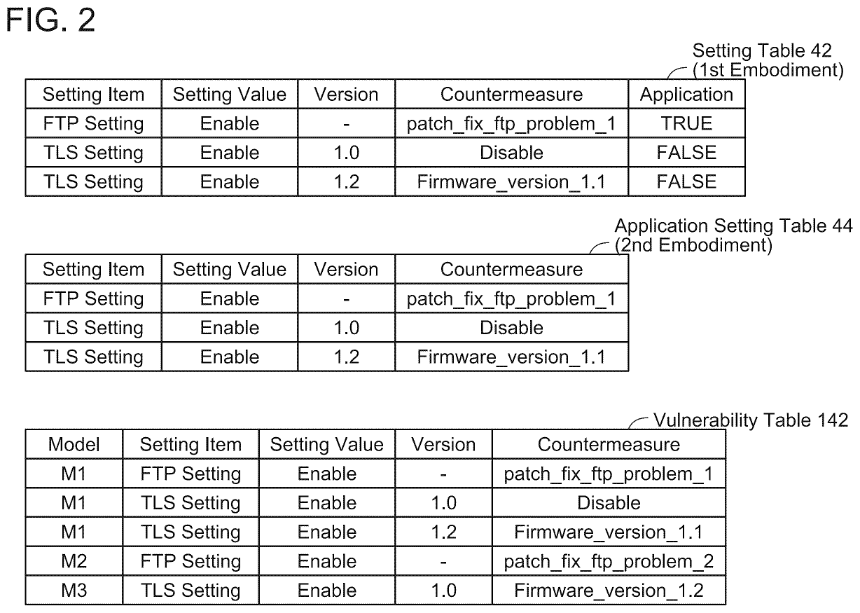

### Contents of Tables: FIG. 2

Referring to FIG. 2, contents of the tables 42 and 142 stored in the printer 10 and the server 100, respectively are described.

In the setting table 42 stored in the printer 10, setting items (e.g., “FTP (file transfer protocol) setting”, “TLS (transport layer security) setting”), setting values (e.g., “Enable”), versions (e.g., “1.0”, “1.2”), addressing countermeasures (e.g., “patch_fix_ftp_problem_1”, “Disable”, “Firmware_version_1.1”), and application information (e.g., “TRUE”, “FALSE”) are stored in association with each other. Hereinafter, “patch_fix_ftp_problem” and “Firmware_version” are abbreviated as “pffp” and “F”, respectively.

Each setting item is information for identifying a setting item related to a communication protocol of the printer 10. Each setting value indicates whether a communication protocol is used or not. A setting value “Enable” indicates that the communication protocol is used, while a setting value “Disable” indicates that the communication protocol is not used. Each version indicates a version of a communication protocol. Each addressing countermeasure indicates a countermeasure against an external attack to the printer (i.e., a vulnerability of the printer). The addressing countermeasures include applying a patch program (e.g., “pffp1”, “pffp2”), changing the setting value “Enable” to the setting value “Disable”, and updating firmware of the printer 10. Each application information indicates a value on whether an addressing countermeasure has been applied or not. Application information “TRUE” indicates that an addressing countermeasure has been applied, while application information “FALSE” indicates that an addressing countermeasure has not been applied.

In the vulnerability table 142 stored in the server 100, models (e.g., “M1”, “M2”, “M3”), setting items, setting values, versions, and addressing countermeasures are stored in association with each other. Each model indicates a model name of a printer. When finding that communication protocols have vulnerabilities to external attacks, vendors of printers register information including addressing countermeasures in the vulnerability table 142.

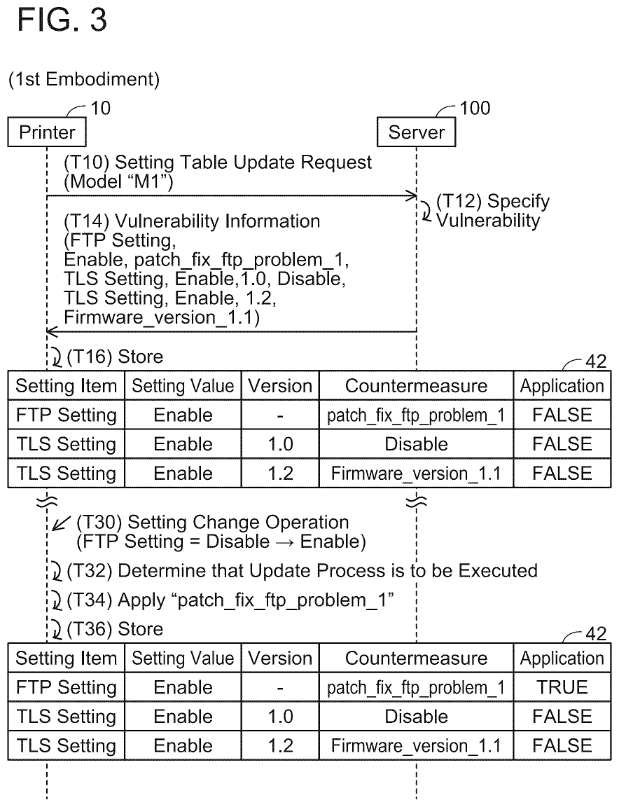

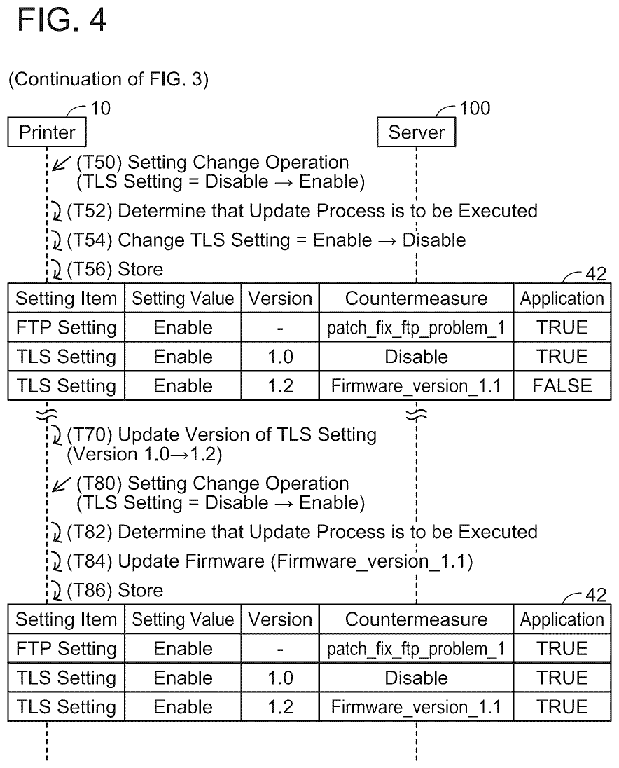

### Specific Process: FIGS. 3 and 4

Referring to FIGS. 3 and 4, a process for addressing an attack from an external device (not shown) to the printer 10 is described. Hereinafter, to aid understanding, actions executed by the CPU 32 of the printer 10 and the CPU 132 of the server 100 according to the programs 40, 140 are described with the printer 10 and the server 100 as the subjects of the actions, instead of described with the CPUs 32, 132 as the subjects of the actions. In the following description, all communications executed by the printer 10 and the server 100 are via the communication I/Fs 16, 116. Thus, in the following description, a phrase “via the communication I/F 16 (or 116)” is omitted.

In the initial state of the process shown in FIG. 3, the setting table 42 in the printer 10 stores no information therein and the version of communication protocol TLS in the printer 10 is 1.0. The process shown in FIG. 3 is started at a predetermined time. The predetermined time is for example when the printer 10 is turned on, a predefined time, or the like.

In T10, the printer 10 sends a setting table update request including a model name “M1” of the printer 10 to the server 100.

In response to receiving the setting table update request from the printer 10 in T10, the server 100 specifies, in the vulnerability table 142, sets of information each including a setting item, setting value, version, and addressing countermeasure associated with the model name “M1”, which is included in the setting table update request, in T12. In other words, this means specifying vulnerabilities of the printer 10 with the model name “M1”. In the vulnerability table 142, three sets of information are stored in association with the model name “M1”. Specifically, a first set of information includes a setting item “FTP setting”, the setting value “Enable”, a version “-”, and an addressing countermeasure “pffp1”; a second set of information includes a setting item “TLS setting”, the setting value “Enable”, a version “1.0”, and an addressing countermeasure “Disable”; and a third set of information includes the setting item “TLS setting”, the setting value “Enable”, a version “1.2”, and an addressing countermeasure “F1.1”. In T14, the server 100 sends vulnerability information including the specified three sets of information to the printer 10.

When communication according to FTP is permitted in a printer (e.g., 10) (i.e., when the setting value for the FTP setting is changed from “Disable” to “Enable” in the printer), the printer may be subjected to external attacks through the communication according to FTP. That is, the communication protocol FTP has a vulnerability to external attacks. Thus, the first set of information including a patch program “pffp1” for addressing this vulnerability is registered in the server 100. By receiving the first set of information from the server 100, the printer can use the patch program and thus address the vulnerability.

It has been confirmed that when communication according to the version 1.0 of TLS is permitted in a printer (e.g., 10) (i.e., when the setting value for the TLS setting is changed from “Disable” to “Enable” in the printer in which the version of TLS is 1.0), the probability of the printer being subjected to external attacks through the communication according to TLS is increased. That is, it has been confirmed that the communication protocol TLS tends to have a vulnerability to external attacks. Thus, the second set of information including the addressing countermeasure “Disable” for addressing this vulnerability is registered in the server 100. In response to receiving the second set of information from the server 100, the printer changes the setting value for the TLS setting from “Enable” to “Disable”, i.e., prohibits communication according to the version 1.0 of TLS.

When communication according to the version 1.2 of TLS is permitted in a printer (e.g., 10) (i.e., when the setting value for the TLS setting is changed from “Disable” to “Enable” in the printer in which the version of TLS is 1.2), the printer may be subjected to external attacks through communication according to TLS. Since the version 1.2 of TLS is less vulnerable to external attacks than the version 1.0 of TLS, it is not necessary to change the setting value for the TLS setting from “Enable” to “Disable” in the printer. However, if firmware effective against external attacks is developed, it is desirable to apply this firmware to the printer. In this embodiment, the third set of information including an addressing countermeasure “F1.1” is registered in the server 100. After receiving the third set of information from the server 100, the printer can update its firmware.

In response to receiving the vulnerability information from the server 100 in T14, the printer 10 stores the three sets of information included in the vulnerability information in the setting table 42 in T16. Since the addressing countermeasures included in these sets of information have not been applied to the printer 10 yet, all the application information in the sets of information indicate “FALSE”.

Thereafter, in T30, the printer 10 receives from a user a setting change operation for changing the setting value for the FTP setting from “Disable” to “Enable”. In this case, the printer 10 determines in T32 that the update process is to be executed because “FTP setting” and “Enable”, which are the contents of the setting change, are associated with the addressing countermeasure “pffp1” and the application information “FALSE” in the setting table 42. In other words, the printer 10 determines that the update process is not to be executed when a set of information including “FTP setting” and “Enable” is not in the setting table 42 or when a set of information including “FTP setting” and “Enable” is in the setting table 42 but the application information included therein indicates “TRUE”.

More specifically, based on a letter string “patch” included in the addressing countermeasure “pffp1 (i.e., patch_fix_ftp_problem_1)” associated with “FTP setting” and “Enable”, the printer 10 determines that the patch program is to be applied to the printer 10. Especially, the printer 10 determines that the patch program “pffp1” of the addressing countermeasure is to be applied. Then, in T34, the printer 10 applies the patch program “pffp1” by adding the patch program “pffp1” to the program 40. This allows the printer 10 to address the vulnerability resulting from the change of the setting value for “FTP setting” from “Disable” to “Enable” in T30. After the update process has been completed, in T36 the printer 10 stores the application information “TRUE”, in place of the application information “FALSE”, in association with the set of information including “FTP setting” and “Enable”.

Then, in T50 of FIG. 4, the printer 10 receives from the user a setting change operation for changing the setting value for the TLS setting from “Disable” to “Enable”. In this case, the printer 10 determines in T52 that the update process is to be executed because “TLS setting” and “Enable”, which are the contents of the setting change, are associated with the version “1.0”, which matches the current version of TLS in the printer 10, the addressing countermeasure “Disable”, and the application information “FALSE” in the setting table 42. In other words, the printer 10 determines that the update process is not to be executed when a set of information including “TLS setting” and “Enable” is not in the setting table 42, when a set of information including “TLS setting” and “Enable” is in the setting table 42 but the version included in the set of information does not match the current version of TLS in the printer 10, or when a set of information including “TLS setting” and “Enable” is in the setting table 42 but the application information included in the set of information indicates “TRUE”.

More specifically, based on the letter string “Disable” included in the addressing countermeasure “Disable” associated with “TLS setting”, “Enable”, and “1.0”, the printer 10 determines that the setting value for the TLS setting is to be changed from “Enable” to “Disable”. Then, the printer 10 changes the setting value for the TLS setting from “Enable” to “Disable” in T54. That is, the printer 10 cancels the setting change operation received from the user in T50. This allows the printer 10 to address the vulnerability resulting from the change of the setting value for “TLS setting” from “Disable” to “Enable” in T50. After the update process has been completed, the printer 10 stores the application information “TRUE”, in place of the application information “FALSE”, in association with the set of information including “TLS setting”, “Enable”, and “1.0” in T56.

Thereafter, the printer 10 updates the version of TLS from 1.0 to 1.2 in T70, and then receives from the user a setting change operation for changing the setting value for the TLS setting from “Disable” to “Enable” in T80. In this case, the printer 10 determines in T82 that the update process is to be executed because “TLS setting” and “Enable”, which are the contents of the setting change, are associated with the version “1.2”, which matches the current version of TLS in the printer 10, the addressing countermeasure “F1.1”, and the application information “FALSE” in the setting table 42. In other words, the printer 10 determines that the update process is not to be executed when a set of information including “TLS setting” and “Enable” is not in the setting table 42, when a set of information including “TLS setting” and “Enable” is in the setting table 42 but the version included in the set of information does not match the current version of TLS in the printer 10, or when a set of information including “TLS setting” and “Enable” is in the setting table 42 but the application information included in the set of information indicates “TRUE”.

More specifically, based on a letter string “Firmware” included in the addressing countermeasure “F1.1 (i.e., Firmware_version_1.2)” associated with “TLS setting”, “Enable”, and “1.2”, the printer 10 determines that the firmware of the printer 10 is to be updated. Especially, the printer 10 determines that the firmware of the printer 10 is to be updated to the firmware “F1.1” of the addressing countermeasure. Then, the printer 10 updates the current firmware included in the program 40 to the firmware “F1.1” in T84. This allows the printer 10 to address the vulnerability resulting from the change of the setting value for “TLS setting” from “Disable” to “Enable” in T80. After the update process has been completed, the printer 10 stores the application information “TRUE”, in place of the application information “FALSE”, in association with the set of information including “TLS setting”, “Enable”, and “1.2” in T86.

The printer 10 and the server 100 execute the sequence from T10 to T16 in FIG. 3 every time a predetermined time comes. That is, the sequence from T10 to T16 is executed regularly. Especially, when a new set of information is added to the vulnerability table 142 in the server 100, the printer 10 receives vulnerability information including this new set of information from the server 100. In this case, the printer 10 stores the new vulnerability information in the setting table 42. Thus, the latest vulnerability information stored in the server 100 is reflected in the setting table 42. Therefore, the printer 10 can appropriately address new external attacks.

### Advantageous Effects of Embodiment

According to the configuration above, the printer 10 detects the change of the setting value for FTP or TLS from “Disable” to “Enable”, and then if determining that the update process is to be executed, executes the update process (T34 in FIG. 3, T54, T84 in FIG. 4). The update process is for updating the data stored in the memory 34 of the printer 10 to address a vulnerability of the printer 10 resulting from the change of the setting value for FTP or TLS in the printer 10. This update includes one of applying a patch program (T34), changing a setting value (T54), and updating firmware (T84). Thus, the printer 10 can address a vulnerability resulting from the change of the setting value for FTP or TLS.

### Correspondence Relationships

The controller 30 of the printer 10 and the printer 10 are examples of “control device” and “communication device”, respectively. “Disable” and “Enable” are examples of “first value” and “second value”, respectively. Applying the patch program “pffp1”, changing a setting value to “Disable”, and updating the firmware of the printer 10 are examples of “update process”. In the case of applying the patch program “pffp1” or updating the firmware of the printer 10, the program 40 is an example of “data”. In the case of changing a setting value to “Disable”, the setting value is an example of “data”. FTP and TLS are examples of “communication protocol”.

T30 in FIGS. 3 and T50 and T80 in FIG. 4 are examples of “detect a change of a specific setting value”. T32 in FIGS. 3 and T52 and T82 in FIG. 4 are examples of “determine whether an update process is to be executed”. T34 in FIGS. 3 and T54 and T84 in FIG. 4 are examples of “execute the update process”. T14 and T16 in FIG. 3 are examples of “receive vulnerability information” and “store the vulnerability information in the memory”, respectively.

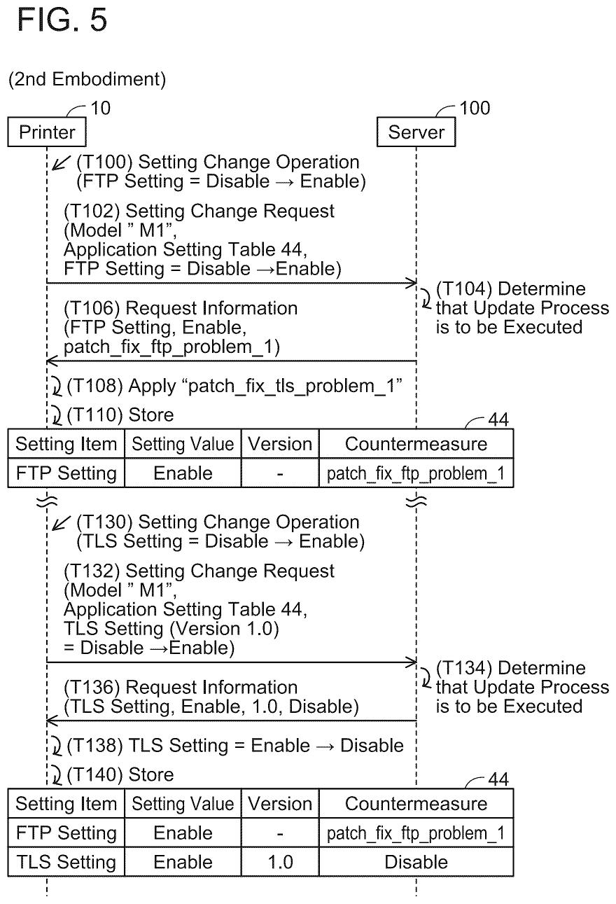

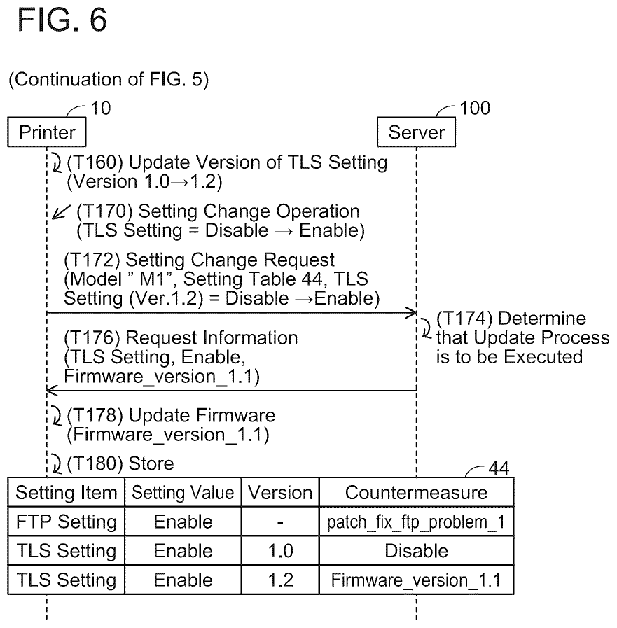

### Second Embodiment: FIGS. 5 and 6

Now, a second embodiment is described. In this embodiment, as shown in FIG. 1, the memory 34 of the printer 10 stores an application setting table 44, instead of the setting table 42 as in the first embodiment. As shown in FIG. 2, setting items, setting values, versions, and addressing countermeasures are stored in association with each other in the application setting table 44. The application setting table 44 is information indicating addressing countermeasures that have been applied to the printer 10. In the initial state of the process shown in FIG. 5, the application setting table 44 in the printer 10 stores no information therein and the version of the communication protocol TLS in the printer 10 is 1.0.

In T100, the printer 10 receives from the user a setting change operation for changing the setting value for the FTP setting from “Disable” to “Enable”. In this case, in T102, the printer 10 sends the server 100 a setting change request including the model name “M1” of the printer 10, the application setting table 44 in which no information is stored yet, and change information indicating that the setting value for the FTP setting has been changed from “Disable” to “Enable”.

In response to receiving the setting change request from the printer 10 in T102, the server 100 specifies, in the vulnerability table 142, the addressing countermeasure “pffp1” associated with the information included in the setting change request in T104. Specifically, the server 100 specifies the addressing countermeasure “pffp1” associated with the model “M1” and the contents of the setting change (i.e., FTP setting and “Enable”) indicated by the change information. In other words, this means specifying an addressing countermeasure against a vulnerability resulting from the change of the setting value for FTP setting to “Enable” in the printer 10 with the model name “M1”. Then, the server 100 determines whether a set of information including the FTP setting, “Enable”, and the specified addressing countermeasure “pffp1” is in the received application setting table 44. In the present case, the server 100 determines that the above set of information is not in the application setting table 44 and determines that the update process is to be executed. When a set of information including the model “M1”, FTP setting, and “Enable” is not in the vulnerability table 142 or when this set of information is in the application setting table 44, the server 100 determines that the update process is not to be executed.

In T106, the server 100 executes the update process. Specifically, the server 100 sends request information including the setting item “FTP setting”, the setting value “Enable”, and the specified addressing countermeasure “pffp1” to the printer 10.

In response to receiving the request information from the server 100 in T106, based on the letter string “patch” included in the addressing countermeasure “pffp1 (i.e., patch_fix_ftp_problem_1)” in the request information, the printer 10 determines in T108 that the patch program is to be applied to the printer 10. Then, the printer 10 applies the patch program “pffp1” by adding the patch program “pffp1” to the program 40 in T108. This allows the printer 10 to address the vulnerability resulting from the change of the setting value for FTP setting from “Disable” to “Enable” in T100. Thereafter, the printer 10 stores a set of information including the setting item “FTP setting”, the setting value “Enable”, and the addressing countermeasure “pffp1” in the application setting table 44 in T110.

In T130, the printer 10 receives from the user a setting change operation for changing the setting value for the TLS setting from “Disable” to “Enable”. In this case, in T132, the printer 10 sends the server 100 a setting change request including the model name “M1” of the printer 10, the application setting table 44, the current version “1.0” of TLS, and change information indicating that the setting value for the TLS setting has been changed from “Disable” to “Enable”.

In response to receiving the setting change request from the printer 10 in T132, the server 100 specifies, in the vulnerability table 142, the addressing countermeasure “Disable” associated with the information included in the setting change request in T134. Specifically, the server 100 specifies the addressing countermeasure “Disable” associated with the model “M1”, the contents of the setting change (i.e., TLS setting and “Enable”) indicated by the change information, and the version “1.0”. In other words, this means specifying an addressing countermeasure against a vulnerability resulting from the change of the setting value for TLS setting related to the version “1.0” of TLS to “Enable” in the printer 10 with the model name “M1”. Then, the server 100 determines whether a set of information including the TLS setting, “Enable”, the version “1.0”, and the specified addressing countermeasure “Disable” is in the received application setting table 44. In the present case, the server 100 determines that the above set of information is not in the application setting table 44 and determines that the update process is to be executed. When a set of information including the model “M1”, the TLS setting, “Enable”, and the version “1.0” is not in the vulnerability table 142 or when this set of information is in the application setting table 44, the server 100 determines that the update process is not to be executed.

In T136, the server 100 executes the update process. Specifically, the server 100 sends request information including the setting item “FTP setting”, the setting value “Enable”, the version “1.0”, and the addressing countermeasure “Disable” to the printer 10.

In response to receiving the request information from the server 100 in T136, the printer 10 determines in T138 that the setting value for TLS setting is to be changed from “Enable” to “Disable” based on the letter string “Disable” included in the addressing countermeasure “Disable” in the request information. Then, the printer 10 changes the setting value for the TLS setting from “Enable” to “Disable”. That is, the printer 10 cancels the setting change operation received from the user in T130. This allows the printer 10 to address the vulnerability resulting from the change of the setting value for “TLS setting” from “Disable” to “Enable” in T130. Thereafter, in T140, the printer 10 stores a set of information including the setting item “TLS setting”, the setting value “Enable”, the version “1.0”, and the addressing countermeasure “Disable” in the application setting table 44.

Thereafter, the printer 10 updates the version of TLS from 1.0 to 1.2 in T160 of FIG. 6, and then receives from the user a setting change operation for changing the setting value for the TLS setting from “Disable” to “Enable” in T170. In this case, in T172, the printer 10 sends the server 100 a setting change request including the model name “M1” of the printer 10, the application setting table 44, the current version “1.2” of TLS, and change information indicating that the setting value for TLS setting has been changed from “Disable” to “Enable”.

In response to receiving the setting change request from the printer 10 in T172, the server 100 specifies, in the vulnerability table 142, the addressing countermeasure “F1.1” associated with the information included in the setting change request in T174. Specifically, the server 100 specifies the addressing countermeasure “F1.1” associated with the model “M1”, the contents of the setting change (i.e., TLS setting and “Enable”) indicated by the change information, and the version “1.2”. In other words, this means specifying an addressing countermeasure against the vulnerability resulting from the change of the setting value for TLS setting related to the version “1.2” of TLS to “Enable” in the printer 10 with the model name “M1”. Then, the server 100 determines whether a set of information including the TLS setting, “Enable”, the version “1.2”, and the specified addressing countermeasure “F1.1” is in the application setting table 44 included in the received setting change request. In the present case, the server 100 determines that the above set of information is not in the application setting table 44 and determines that the update process is to be executed. When a set of information including the model “M1”, the TLS setting, “Enable”, and the version “1.2” is not in the vulnerability table 142 or when this set of information is in the application setting table 44, the server 100 determines that the update process is not to be executed.

In T176, the server 100 executes the update process. Specifically, the server 100 sends request information including the setting item “TLS setting”, the setting value “Enable”, the version “1.2”, and the specified addressing countermeasure “F1.1” to the printer 10.

In response to receiving the request information from the server 100 in T176, the printer 10 determines in T178 that the firmware of the printer 10 is to be updated based on the letter string “Firmware” included in the addressing countermeasure “F1.1” in the request information. Then, the printer 10 updates the current firmware included in the program 40 to “F1.1” in T178. This allows the printer 10 to address the vulnerability resulting from the change of the setting value for “TLS setting” from “Disable” to “Enable” in T170. Then, in T180, the printer 10 stores a set of information including the setting item “TLS setting”, the setting value “Enable”, the version “1.2”, and the specified addressing countermeasure “F1.1” in the application setting table 44.

### Advantageous Effects of Embodiment

According to the configuration above, the server 100 detects the change of setting value for FTP or TLS from “Disable” to “Enable”, and if determining that the update process is to be executed (T104, T134 in FIG. 5, T174 in FIG. 6), sends the request information (T106, T136 in FIG. 5, T176 in FIG. 6). As a result, the data stored in the memory 34 of the printer 10 is updated to address the vulnerability resulting from the change of the setting value for FTP or TLS in the printer 10 (T108, T138 in FIG. 5, T178 in FIG. 6). Thus, the printer 10 can address the vulnerability resulting from the change of the setting value for FTP or TLS.

### Correspondence Relationships

The server 100 is an example of “control device”. T102, T132 in FIGS. 5 and T172 in FIG. 6 are examples of “detect a change of a specific setting value”. T104, T134 in FIGS. 5 and T174 in FIG. 6 are examples of “determine whether an update process is to be executed”. T106, T136 in FIGS. 5 and T176 in FIG. 6 are examples of “execute the update process”. T14 and T16 in FIG. 3 are examples of “receive vulnerability information” and “store the vulnerability information in the memory”, respectively.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

(Modification 1) The sequence from T10 to T16 in FIG. 3 may not be executed regularly. For example, the printer 10 may execute the sequence from T10 to T16 in FIG. 3 in response to receiving the setting change operation from the user in T30 in FIG. 3, or T50 or T80 in FIG. 4. Generally, “receive vulnerability information” may not include receiving vulnerability information regularly.

(Modification 2) “Specific setting item” may not be related to whether the communication device uses the specific communication protocol. For example, “specific setting item” may be related to whether the communication device uses an encryption scheme for communication. In this case, “first value” may indicate that the communication device uses the encryption scheme, and “second value” may indicate that the communication device does not use the encryption scheme. Alternatively, for example, “specific setting item” may be for registering the device name, IP address, etc. of a device that is permitted to communicate (or prohibited from communicating) with the communication device.

(Modification 3) “Update process” may include only updating firmware, only applying a patch program, only changing a setting value, or two of these. Generally, “update process” may include at least one of updating firmware, applying a patch program, and changing a setting value. In another modification, “update process” may not include any of the above listed. That is, “update process” may include any action as long as the action is for updating data stored in the communication device to address a vulnerability of the communication device.

(Modification 4) In the embodiments above, the processes in FIGS. 3 to 6 are implemented by software (e.g., the program 40 of the printer 10, the program 140 in the server 100), however, at least one of these processes may be implemented by hardware such as a logic circuit, etc.

What is claimed is:

1. A control device comprising:
a processor; and
a memory storing computer-readable instructions, wherein the computer-readable instructions, when executed by the processor, cause the control device to:
detect a change of a specific setting value from a first value to a second value in a communication device, wherein the specific setting value corresponds to a specific setting item related to communication;
in a case where the change of the specific setting value from the first value to the second value is detected, determine whether an update process is to be executed based on changed contents of the specific setting value, wherein the update process is for updating data stored in the communication device to address a vulnerability of the communication device resulting from the change of the specific setting value of the communication device; and
in a case where it is determined that the update process is to be executed, execute the update process.

2. The control device as in claim 1, wherein
the memory is configured to further store, for each of a plurality of setting items related to communication in the communication device, changed contents of a setting value and addressing information in association with each other, wherein the changed contents of the setting value correspond to the setting item, and the addressing information is for addressing a vulnerability of the communication device resulting from a change of the setting value,
wherein in a case where specific addressing information is stored in the memory in association with the changed contents of the specific setting value, it is determined that the update process is to be executed,
in a case where the specific addressing information is not stored in the memory in association with the changed contents of the specific setting value, it is determined that the update process is not to be executed, and
in the case where it is determined that the update process is to be executed, the update process is executed in accordance with the specific addressing information.

3. The control device as in claim 2, wherein the control device is a controller of the communication device, and
the computer-readable instructions, when executed by the processor, further causes the control device to:
receive vulnerability information related to the vulnerability of the communication device from a server; and
store the vulnerability information in the memory, wherein the vulnerability information includes, for each of the plurality of setting items, changed contents of a setting value corresponding to the setting item and addressing information for addressing the vulnerability of the communication device resulting from a change of the setting value.

4. The control device as in claim 3, wherein
the controller receives new vulnerability information periodically from the server, and
in a case where the new vulnerability information is received from the server, the new vulnerability information is stored in the memory in place of old vulnerability information stored in the memory.

5. The control device as in claim 1, wherein
the specific setting item is related to whether the communication device uses a specific communication protocol,
the first value indicates that the communication device does not use the specific communication protocol, and
the second value indicates that the communication device uses the specific communication protocol.

6. The control device as in claim 5, wherein
the first value indicates that the communication device does not use a predetermined version of the specific communication protocol, and
the second value indicates that the communication device uses the predetermined version of the specific communication protocol.

7. The control device as in claim 1, wherein
the update process includes at least one of: updating firmware of the communication device, applying a patch program to the communication device, and changing the specific setting value.

8. The control device as in claim 7, wherein
the change of the specific setting value includes a change of the specific setting value from the second value to the first value.

9. The control device as in claim 1, wherein the control device is a server communicable with the communication device,
in a case where change information indicating the change of the specific setting value from the first value to the second value is received from the communication device, the change of the specific setting value from the first value to the second value is detected, and
the update process includes sending request information to the communication device, wherein the request information requests an update of the data stored in the communication device.

10. A non-transitory computer-readable storage medium storing computer-readable instructions for a control device, wherein
the computer-readable instructions, when executed by a processor of the control device, cause the control device to:
detect a change of a specific setting value from a first value to a second value in a communication device, wherein the specific setting value corresponds to a specific setting item related to communication;
in a case where the change of the specific setting value from the first value to the second value is detected, determine whether an update process is to be executed based on changed contents of the specific setting value, wherein the update process is for updating data stored in the communication device to address a vulnerability of the communication device resulting from the change of the specific setting value of the communication device; and
in a case where it is determined that the update process is to be executed, execute the update process.

11. A method executed by a control device, the method comprising:
detecting a change of a specific setting value from a first value to a second value in a communication device, wherein the specific setting value corresponds to a specific setting item related to communication;
in a case where the change of the specific setting value from the first value to the second value is detected, determining whether an update process is to be executed based on changed contents of the specific setting value, wherein the update process is for updating data stored in the communication device to address a vulnerability of the communication device resulting from the change of the specific setting value of the communication device; and
in a case where it is determined that the update process is to be executed, executing the update process.
